(19) United States
(12) Patent Application Publication
(10) Pub. No.: US 2010/0230463 A1
(43) Pub. Date: Sep. 16, 2010

(54) Nail Box for T-shaped, L-shaped and U-shaped Nails of Nail-Shooting Gun

(75) Inventor: Mingjun Yang, Zhejiang (CN)

Correspondence Address: GLOBAL IP SERVICES, 7285 W. Eagle Court, Winton, CA, 95388, US

(73) Assignee: TAIZHOU DAJIANG IND. CO., LTD., Wenling, Zhejiang (CN)

(21) Appl. No.: 12/741,203

(22) PCT Filed: Apr. 3, 2008
(86) PCT No.: PCT/CN08/00686

§ 371 Date: May 4, 2010

(30) Foreign Application Priority Data
Nov. 23, 2007 (CN) CN200720305252.0

(51) Int. Cl. B25C 1/00

(52) U.S. Cl. 227/109; 227/127

(57) ABSTRACT

The present invention discloses a nail box for T-shaped, L-shaped and U-shaped nails of nail-shooting gun, comprising: a groove seat provided to be straddled and slid by the U-shaped nails, one end of the groove seat is connected with the head of the nail-shooting gun; a nail clamp arranged at a side face of the groove seat to form a containing groove between the nail clamp and the groove seat to be passed by a nail; a nail-pushing block having an U-shaped cross section and connected with the body of the nail-shooting gun by an elastic element to push the nail to move toward the head of the nail-shooting gun along the containing groove; characterized in that: two convex stripes are oppositely arranged on an inner wall of the containing groove adjacent to the top of the groove seat. The usage range of the nail box according to the present invention can be extended, and the nail box is more convenient for users.

### FIELD OF THE INVENTION

The present invention relates to a nail box of nail-shooting gun, and more particularly, to a nail box suitable for T-shaped, L-shaped and U-shaped nails of nail-shooting gun.

### BACKGROUND OF THE INVENTION

Referring to a structure of the prior nail-shooting gun, the nail box is developed relatively mature enough to be suitable for an alternative utilization of T-shaped and U-shaped nails, or for an alternative utilization of T-shaped and L-shaped nails, or for an alternative utilization of U-shaped and L-shaped nails. However, in company with extending of application range of nail-shooting gun and increasing of the nail shapes, operation practice puts forward more advanced requests for versatility of the nails setting in the nail box. In nailing operation, nail box may be required to be not only suitable for an alternative utilization of T-shaped and U-shaped nails, or for an alternative utilization of T-shaped and L-shaped nails, or for an alternative utilization of U-shaped and L-shaped nails, but also be suitable for T-shaped, L-shaped and U-shaped nails. Meanwhile, in a high-frequency nailing operation, it is required to further improve the abrasion resistance of channels in nail passing grooves arranged in the nail box.

For example, referring to Chinese Patent announcement number CN2340569Y, it discloses that a nail box for the T-shaped and U-shaped nails of a nail-shooting gun, comprising a groove seat and a sliding box forming a slide fit with the periphery of the groove seat; the sliding box is provided with a sheathing space in axial direction; the wall surfaces of the sheathing space separating from the groove seat to arrange the U-shaped nails; and the surfaces of one side of the groove seat and the wall surfaces of the sheathing space of the sliding box is provided with a plurality of opposite groove channels for arranging the T-shaped nails with different lengths. The technical solution disclosed above is advantageous in that the nail box is suitable for the U-shaped and the T-shaped nails, and the U-shaped and the T-shaped nails are arranged in the same way, and the movement of arranging the nails is simple. The disadvantages of the technical solution disclosed above are that the prior nail box is only suitable for the T-shaped and the U-shaped nails, while not suitable for the L-shaped nails; and the above-mentioned patent document No.: CN2340569Y does not disclose the technical designs that the abrasion resistance of channel materials can be higher than that of the groove seat and the sliding box, so the groove channels may be the first to be frayed in nailing operation, more particularly in high-frequency nailing operation, thereby the service life of the entire nail box will be reduced.

### SUMMARY OF THE INVENTION

The present invention aims to solve the above technical problem, and provide a nail box with higher abrasion resistance for T-shaped, U-shaped and L-shaped nails of nail-shooting gun with lower costs.

The technical solution adopted by the present invention to solve the above technical problem is as follows: a nail box for T-shaped, L-shaped and U-shaped nails of nail-shooting gun, comprising:

a nail clamp, which having a containing groove to be passed by T-shaped, L-shaped or U-shaped nails, one end of the nail clamp is arranged with a bracket, and the opposite end of the nail clamp is connected with a head of the nail-shooting gun;

a nail-pushing block, which is matched with the nail clamp, and is connected with the head of the gun body of the nail-shooting gun by an elastic element for pushing T-shaped, L-shaped or U-shaped nails to move toward the head of the nail-shooting gun along the containing groove;

a nail clamp protective shell, which is arranged glidingly on the exterior of the nail clamp, and can be opened or closed relative to the nail clamp, after the nail clamp protective shell is closed, the nail clamp protective shell keeps a certain distance from the nail clamp to form an enclosed space, the enclosed space is together with the containing groove to form a nail passing channel for containing and passing nails;

the containing groove has an L-shaped cross section, and two grooves, which are oppositely arranged on two inner walls of the curly part of the containing groove respectively, two inlaid stripes having L-shaped cross sections are embed into the two grooves respectively; outcrops of the two inlaid stripes exposed on the inside wall of containing groove.

The nail passing channel on the head of the gun is formed as U-shaped, and is aligned to connect with the nail passing channel formed by the nail clamp and the nail clamp protective shell, an end of the nail-pushing block is formed as U-shaped.

The U-shaped end of the said nail-pushing block is tooth shape.

Two grooves for inlaid are an L-shaped cross section, and the said inlaid stripes are comprise an L-shaped cross section too.

The said elastic element hitches the end of the said nail clamp by a pothook.

The optimal lengths of the outcrops of the said inlaid stripes are in the range of 0.5-5 mm.

The optimal length of the outcrops of the said inlaid stripes is in range of 0.8 mm.

The said inlaid stripes may be iron inlaid stripes or steel inlaid stripes.

The head of the nail-shooting gun comprises a mouth and a cover board, and the nail passing channel on the mouth of the gun is formed as U-shaped.

Compared with the prior art, the advantages of the technical solution provided by the present invention are as follows: the nail box can be applied for T-shaped, L-shaped and U-shaped nails of nail-shooting gun, due to two convex stripes are applied on the top of the nail containing groove enclosed by the groove seat and the nail clamp, so that the application range of the nail box can be extended for T-shaped, U-shaped and L-shaped nails, and the nail box is more convenient for users; meanwhile, as the inlaid stripes structure is applied, the abrasion of the containing groove in the nailing box may be avoided, the service life of the entire nail box can be largely increased, the cost of the nail box is reduced, and the steadiness of nail feeding is improved.

### BRIEF DESCRIPTION OF THE DRAWINGS

FIG. 1 is a front view of the present invention;

FIG. 2 is a disassembly front view of the present invention;

FIG. 3 is a cross sectional view along lines 4-4 of FIG. 1 showing a containing groove in which T-shaped nail is arranged according to an embodiment of the present invention;

FIG. 4 is a cross sectional view along lines 4-4 of FIG. 1 showing a containing groove in which U-shaped nail is arranged according to an embodiment of the present invention;

FIG. 5 is a cross sectional view along lines 4-4 of FIG. 1 showing a containing groove in which U-shaped nail is arranged according to an embodiment of the present invention;

FIG. 6 is a cross sectional view along lines 3-3 of FIG. 1 showing a head of the gun according to an embodiment of the present invention.

### DETAILED DESCRIPTION OF THE INVENTION

Hereinafter, embodiments of the present invention will be described with reference to the accompanying drawings.

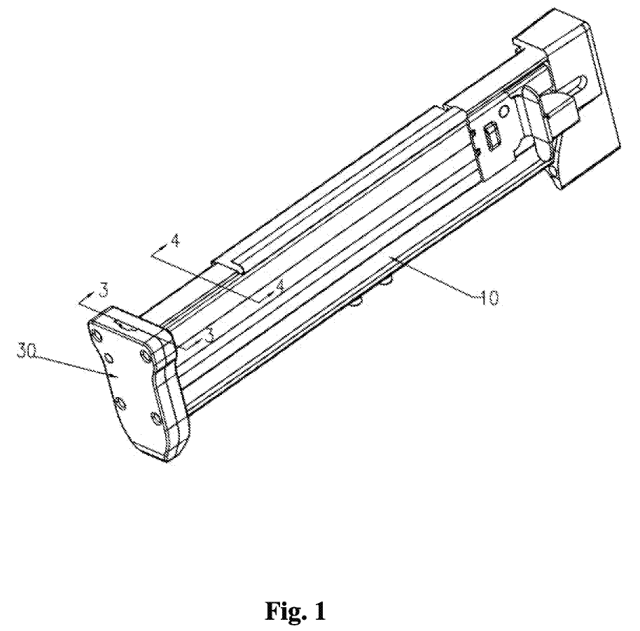

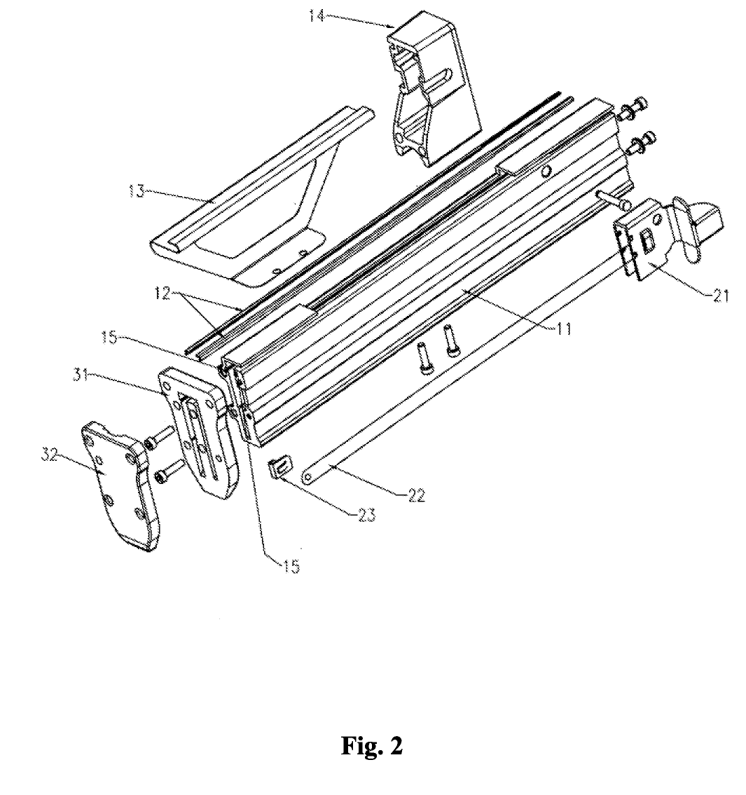

Referring to FIGS. 1 and 2, a nail box 10 with higher abrasion resistance for T-shaped, L-shaped and U-shaped nails of nail-shooting gun according to the present invention comprises:

A nail clamp 11, which having a containing groove P to be passed by T-shaped, L-shaped or U-shaped nails. One end of the nail clamp 11 is arranged with a bracket 14, and the opposite end of the groove seat 16 and the nail clamp 11 is connected with the head 30 of a nail-shooting gun;

a nail-pushing block 21, which is matched with the nail clamp 11, and is connected with the head 30 of the gun body of the nail-shooting gun by an elastic element 22 for pushing T-shaped, L-shaped or U-shaped nails to move toward the head 30 of the nail-shooting gun along the containing groove P,

A nail clamp protective shell 13, which is arranged glidingly on the exterior of the nail clamp 11, and can be opened or closed relative to the nail clamp 11. After the nail clamp protective shell 13 is closed, the nail clamp protective shell 13 keeps a certain distance from the nail clamp 11 to form an enclosed space. The enclosed space is together with the containing groove P so as to form a nail passing channel for containing and passing nails.

the containing groove P has an L-shaped cross section and two grooves 15, which are oppositely arranged on two inner walls of the curly part of the containing groove P respectively, and each of the grooves 15 comprises an L-shaped cross section, two inlaid stripes 12 having L-shaped cross sections are embed into the two convex stripes respectively; after the inlaid stripes 12 are set in the grooves 15, parts of the inlaid stripes 12 are protruding out of the opening of the L-shaped grooves to form a space between the opposite protruding parts of the inlaid stripes 12 at the both sides of the containing groove for the nail to pass through.

The optimal lengths of the protruding parts of the inlaid stripes 12 are in the range of 0.5-5 mother most optimal length is range of 0.8 mm.

The inlaid stripes 12 may be formed of iron or steel materials which are wearable in nailing operation. As which abraded most is the nail passing channel in the nail box of the nail-shooting gun, the wearable iron or steel materials applied to the local place passed by nails in the containing groove P can improve the abrasion resistance of the nail passing channel, so that the service life of the entire nail box can be improved in a certain degree.

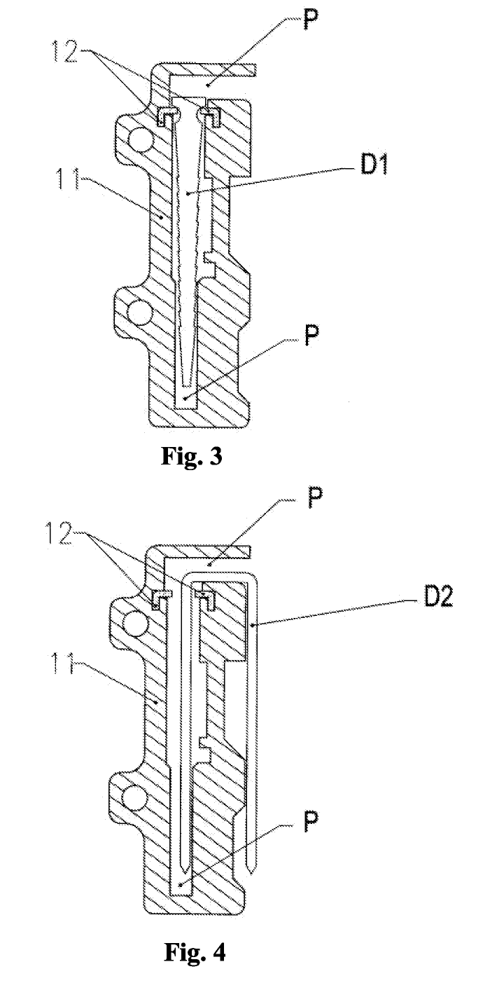

Referring to FIG. 3, in the case of applying T-shaped nail D1 according to an embodiment of the present invention, the nail clamp protective shell 13 is opened to expose the nail containing groove P of the nail clamp 11. Then, the T-shaped nail range is arranged in the nail containing groove P. As the iron inlaid stripes protrudes out of the inner wall of the nail containing groove P, the both sides of the head of the T-shaped nail can be supported by the iron inlaid stripes 12. Next, the nail clamp protective shell 13 is closed relative to the nail clamp 11. After the nail clamp protective shell 13 is closed, the nail clamp protective shell 13 keeps a certain distance from the nail clamp 11 to form an enclosed space. The formed enclosed space combines with the containing groove P to form a nail passing channel and a space for the movement of the nail-pushing block 21. The head of the T-shaped nail is gliding pushed on the iron inlaid stripes 12 by the nail-pushing block 21 to perform nail feeding. The end of the nail-pushing block 21 is formed to be U-shaped, and then the U-shaped end of the nail-pushing block is extruded as tooth shape in order to increase the specification of nails to be used. As the iron inlaid stripes 12 is applied according to this embodiment of the present invention, the nail box 10 can be suitable for T-shaped nail, and the abrasion resistance of the nail clamp 11 is increased, so that the service life of the entire nail box 10 can be largely improved. Moreover, as the iron inlaid stripes 12 is used to provide the support power according to this embodiment of the present invention, the steadiness of nail feeding is improved.

Referring to FIG. 4, in the case of applying U-shaped nail D2 according to another embodiment of the present invention, the nail clamp protective shell 13 is opened to expose the nail containing groove P of the nail clamp 11. Then, the opening of the U-shaped nail range faces down so as to straddle on the nail clamp 11. Next, the nail clamp protective shell 13 is closed relative to the nail clamp 11. After the nail clamp protective shell 13 is closed, the nail clamp protective shell 13 keeps a certain distance from the nail clamp 11 to form an enclosed space. The formed enclosed space combines with the containing groove P to form a nail passing channel. One nail claw of the U-shaped nail is located in the containing groove P, and the other one is hanged in the space of the nail passing channel. The U-shaped nail is gliding pushed on the nail clamp 11 by the nail-pushing block 21 to perform nail feeding. The end of the nail-pushing block 21 is formed to be U-shaped, and then the U-shaped end of the nail-pushing block is extruded as tooth shape in order to increase the specification of nails to be used.

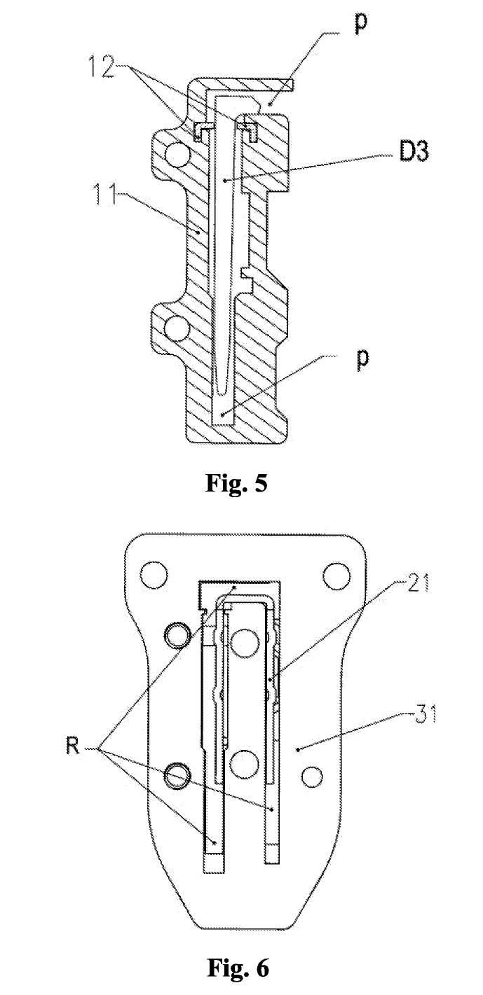

Referring to FIG. 5, in the case of applying L-shaped nail D3 according to a further embodiment of the present invention, the nail clamp protective shell 13 is opened to expose the nail containing groove P of the nail clamp 11. Then, the L-shaped nail range is arranged in the nail containing groove P arranged on the nail clamp 11. Next, the nail clamp protective shell 13 is closed relative to the nail clamp 11. After the nail clamp protective shell 13 is closed, the nail clamp protective shell 13 keeps a certain distance from the nail clamp 11 to form an enclosed space. The formed enclosed space combines with the containing groove P to form a nail passing channel. The head of the L-shaped nail is gliding pushed on the nail clamp 11 by the nail-pushing block 21 to perform nail feeding. The end of the nail-pushing block 21 is formed to be U-shaped, and then the U-shaped end of the nail-pushing block is extruded as tooth shape in order to increase the specification of nails to be used.

Referring to FIG. 6, the head of the gun according to the present invention comprises a mouth 31 and a cover board 32. The nail passing channel R on the mouth 31 of the gun is formed to be U-shaped, and is aligned to connect with the nail passing channel formed by the nail clamp 11 and the nail clamp protective shell 13, so that the nail-shooting gun can shoot different shapes of nails.

The specific embodiments discussed are merely illustrative of specific ways to make and use the invention, and do not limit the scope of the invention. Meanwhile, it should be appreciated that various modifications and their equivalents can be devised by those skilled in the art and will fall within the spirit and scope of the principles of the disclosure.

1. A nail box for T-shaped, L-shaped and U-shaped nails of nail-shooting gun comprising:
a nail clamp, which having a containing groove to be passed by T-shaped, L-shaped or U-shaped nail, one end of the nail clamp is arranged with a bracket, and opposite end of the nail clamp is connected with a head of the nail-shooting gun;
a nail-pushing block, which is matched with the nail clamp, and is connected with the head of the nail-shooting gun by an elastic element for pushing T-shaped, L-shaped or U-shaped nail to move toward the head of the nail-shooting gun along the containing groove;
a nail clamp protective shell, which is arranged glidingly on the exterior of the nail clamp, and can be opened or closed relative to the nail clamp, after the nail clamp protective shell is closed, the nail clamp protective shell keeps a certain distance from the nail clamp to form an enclosed space, the enclosed space is together with the containing groove to form a nail passing channel for containing and passing nails;
characterized in that: the containing groove has an L-shaped cross section and two grooves, which are oppositely arranged on two inner walls of the curly part of the containing groove respectively, two inlaid stripes having L-shaped cross section are embed into the two grooves respectively, outcrops of the two inlaid stripes exposed on the inside wall of containing groove.

2. The nail box of nail-shooting gun according to claim 1, wherein a nail passing channel on the head of the gun is formed as U-shaped, and is aligned to connect with the nail passing channel formed by the nail clamp and the nail clamp protective shell, an end of the nail-pushing block is formed as U-shaped.

3. The nail box of nail-shooting gun according to claim 2, wherein the U-shaped end of the said nail-pushing block is tooth shape.

4. The nail box of nail-shooting gun according to claim 2, wherein the two grooves for inlaid are an L-shaped cross section, and the said inlaid stripes are an L-shaped cross section too.

5. The nail box of nail-shooting gun according to claim 4, wherein the elastic element hitches the end of the said nail clamp by a pothook.

6. The nail box of nail-shooting gun according to claim 5, wherein the optimal lengths of the protruding parts of the said inlaid stripes is in range of 0.5-5 mm.

7. The nail box of nail-shooting gun according to a claim 6, wherein the optimal lengths of the protruding parts of the said inlaid stripes is in range of 0.8 mm.

8. The nail box of nail-shooting gun according to claims 1, wherein the inlaid stripe may be iron inlaid stripe or steel inlaid stripe.

9. The nail box of nail-shooting gun according to claims 1, wherein the head of the nail-shooting gun comprises a mouth and a cover board, and the nail passing channel on the mouth is formed as U-shaped.
